(19) United States
(12) Patent Application Publication
(10) Pub. No.: US 2022/0386129 A1
(43) Pub. Date: Dec. 1, 2022

(54) REMOTE TECHNICAL SUPPORT SERVICE

(71) Applicant: HEWLETT-PACKARD DEVELOPMENT COMPANY, L.P., Spring, TX (US)

(72) Inventors: CHIEN-PAI LAI, TAIPEI CITY (TW); CHUNG-CHUN CHEN, TAIPEI CITY (TW); MENG-HUA TAN, TAIPEI CITY (TW)

(21) Appl. No.: 17/329,637

(22) Filed: May 25, 2021

(51) Int. Cl. H04W 12/55; H04W 4/80; G06F 21/32; G06F 21/71; G06F 9/4401

(52) U.S. Cl. CPC H04W 12/55; H04W 4/80; G06F 21/32; G06F 21/71; G06F 9/4416

(57) ABSTRACT

Examples of computing devices for establishing a communication link with a remote device to contact a remote technical support service are described herein. In an example, a computing device may include a cellular communication interface and a processor. The processor may receive a first user input indicative of contacting a remote technical support service for the computing device. Based on the first user input, the processor may further establish a communication link between the computing device and a remote device over the cellular communication interface to contact the remote technical support service when the computing device is unbootable.

### BACKGROUND

A user of a computing device, such as a laptop, a desktop computer, or an All-In-One computer may contact a remote technical support service for fixing of technical issues associated with the computing device.

### BRIEF DESCRIPTION OF FIGURES

The detailed description is provided with reference to the accompanying figures, wherein:

FIG. 1 illustrates a computing device for establishing a communication link with a remote device to contact a remote technical support service, according to an example;

FIG. 2 illustrates a system environment, including a computing device, a remote device, and a Bluetooth device, for establishing a communication link between the computing device and a remote device, according to an example;

FIG. 3 illustrates a computing device for establishing a communication link with a remote device to contact a remote technical support service, according to an example;

FIG. 4 illustrates a flow diagram of a method for contacting a remote technical support service to fix a computing device, according to an example; and

FIG. 5 illustrates a system environment using a non-transitory computer-readable medium for establishing a communication link between a computing device and a remote device to contact a remote technical support service, according to an example.

### DETAILED DESCRIPTION

When a computing device experiences a technical issue, the computing device may be connected to a device providing a remote technical support service for remote fixing of the technical issue. The technical issue may refer to an issue that affects the operation or functioning of the computing device. In an example, the technical issue may make an application non-functional. The remote technical support service is a service platform that enables remote fixing of the technical issue of the computing device. The computing device may contact the remote technical support service, when an operating system of the computing device is functional, i.e., the computing device is bootable. In case the computing device is unbootable, i.e., when the operating system of the computing device is non-functional, the computing device may not be able to operate to connect to the device providing the remote technical support service. When the computing device is unbootable, a user of the computing device may have to make a telephone call to a service provider or read service manuals associated with the computing device, or may have to physically carry the computing device to a service centre to fix the technical issue.

The present subject matter describes example computing devices which may connect to a remote device for remote fixing of the computing device even when the computing device is unbootable.

In an example, a computing device includes a cellular communication interface and a network interface. The cellular communication interface may include a long-term evolution (LTE) category-M (CAT-M) interface and the network interface may include a local area network interface. In accordance with an example, when the computing device is unbootable, when an operating system of the computing device is non-functional, a communication link is established between the computing device and a remote device over the cellular communication interface to contact a remote technical support service. Alternately, when the computing device is bootable, i.e., when the operating system of the computing device is functional, a communication link is established between the computing device and a remote device over the network interface to contact a remote technical support service. Upon establishing the communication link between the computing device and the remote device, over the cellular communication interface or the network interface, as the case may be, a debug log associated with the computing device may be transmitted to the remote device. In response, a solution to be applied on the computing device to fix the computing device may be received through the remote device.

The cellular communication interface, for example, an LTE CAT-M interface enables a data transfer rate that is sufficient to setup a data communication channel or a voice call channel between the computing device and the remote device when the computing device is unbootable. The voice call channel enables an efficient remote fixing of the computing device, as a user of the computing device can speak with the personnel deployed for the remote technical support service to explain and resolve the technical issue.

The computing devices of the present subject matter improve the user experience by contacting the remote technical support service when the computing device is unbootable. The unbootable computing device may be utilized for contacting the remote technical support service, thereby eliminating the use of another user device. The unbootable computing device can contact the remote technical support service without the efforts which are otherwise made by the user, for example, effort of looking for contact detail of a service provider, making a telephone call to the service provider, reading through technical support literature, or physically taking the computing device to a service centre.

The present subject matter is further described with reference to the accompanying figures. Wherever possible, the same reference numerals are used in the figures and the following description to refer to the same or similar parts. It should be noted that the description and figures merely illustrate principles of the present subject matter. It is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

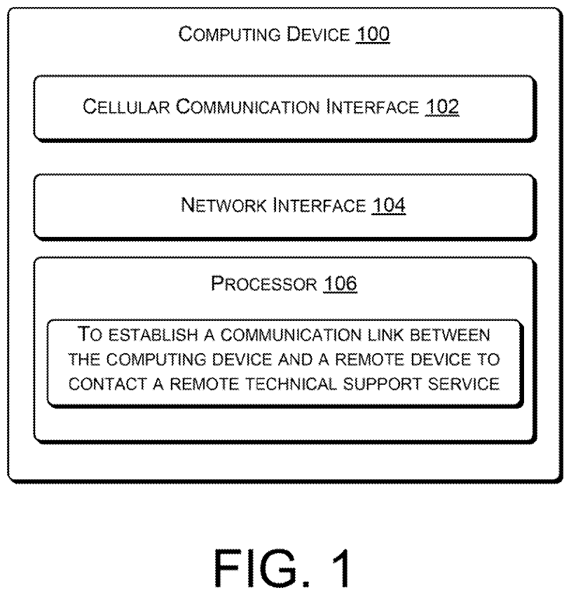

The manner in which the computing devices are implemented are explained in detail with respect to FIGS. 1-5. While aspects of described computing devices can be implemented in any number of different electronic devices, environments, and/or implementations, the examples are described in the context of the following system(s). It is to be noted that drawings of the present subject matter shown here are for illustrative purposes and are not drawn to scale.

FIG. 1 illustrates a computing device 100 for establishing a communication link with a remote device (not shown in FIG. 1) to contact a remote technical support service, according to an example. A remote technical support service is a service platform that may be contacted for enabling remotely fixing a technical issue of a computing device. A technical issue may refer to an issue that affects the operation or functioning of a computing device. Examples of the computing device 100 may include, but are not limited to, a laptop, a notebook computer, a tablet, a smart phone, and a desktop computer. A remote device may refer to a device through which a remote technical support service may be provided to remotely fix the computing device. In an example, the remote device may be a desktop computer, a tablet, a laptop computer, or an All-In-One desktop.

The computing device 100 includes a cellular communication interface 102 and a network interface 104. The cellular communication interface 102 is an interface used to communicate with the remote device when an operating system of the computing device is non-functional, i.e., when the computing device is unbootable. The cellular communication interface 102 may enable the computing device 100 to connect with the remote device over one of a 4G network or a 5G network and to support voice calls between the computing device 100 and the remote device over the 4G network or the 5G network. In an example, the cellular communication interface 102 is a long-term evolution (LTE) category-M (CAT-M) interface. The LTE CAT-M interface operates at 1.4 Megahertz (MHz) bandwidth. The 1.4 MHz bandwidth allows the LTE CAT-M interface to achieve a data transfer rate of up to 1 Megabits per second (Mops) so that the voice calls between the computing device 100 and the remote device may be supported.

Further, the network interface 104 is an interface used to communicate with the remote device when the operating system of the computing device is functional, i.e., when the computing device is bootable. The network interface 104 may enable the computing device 100 to connect to a private network or a public network. In an example, the network interface 104 is a wired local area network interface or a wireless local area network interface. The wired local area network interface may be a wired broadband interface. The wireless local area network interface may be a Wireless-Fidelity (Wi-Fi) interface.

An interface, herein, may refer to a machine-readable instruction based interface, a hardware interface, or a combination thereof that allows the computing device 100 to communicate with various communication and computing devices over communication networks that use a variety of protocols, for example, LTE Protocol, Hypertext Transfer Protocol (HTTP) and Transmission Control Protocol/Internet Protocol (TCP/IP).

The computing device 100 includes a processor 106. The processor 106 is coupled to the cellular communication interface 102 and the network interface 104. The processor 106 may include embedded controllers, microprocessors, microcomputers, microcontrollers, digital signal processors, central processing units, state machines, logic circuitries, and/or any other devices that manipulate signals and data based on computer-readable instructions. Further, functions of the various elements shown in the figures, including any functional blocks labeled as “processor”, may be provided through the use of dedicated hardware as well as hardware capable of executing computer-readable instructions.

In an example, the processor 106 may receive a first user input that indicates that the remote technical support service is to be contacted for fixing the computing device 100. The first user input is an input from a user of the computing device 100 that prompts the processor 106 to contact the remote technical support service. In an example, the first user input may be received in response to pressing a key (not shown) of a keyboard (not shown) of the computing device 100. The keyboard may be a physical keyboard or a virtual keyboard. The key may be a dedicated key that, upon pressing, prompts the computing device 100 to contact the remote technical support service.

When the computing device 100 is unbootable, the processor 106 establishes a first communication link between the computing device 100 and the remote device over the cellular communication interface 102 to contact the remote technical support service based on the first user input. When the computing device 100 is bootable, the processor 106 establishes a second communication link between the computing device 100 and the remote device over the network interface 104 to contact the remote technical support service based on the first user input. The remote technical support service is contacted to debug and fix the technical issue of the computing device 100.

The cellular communication interface in the computing device 100 facilitates contacting the remote technical support service for fixing the technical issue with the computing device 100 even when the computing device 100 is unbootable. Thus, the efforts of the user, such as making a telephone call and reading of technical literature, which are otherwise made or use of another device by the user or carry the computing device to a service centre are eliminated.

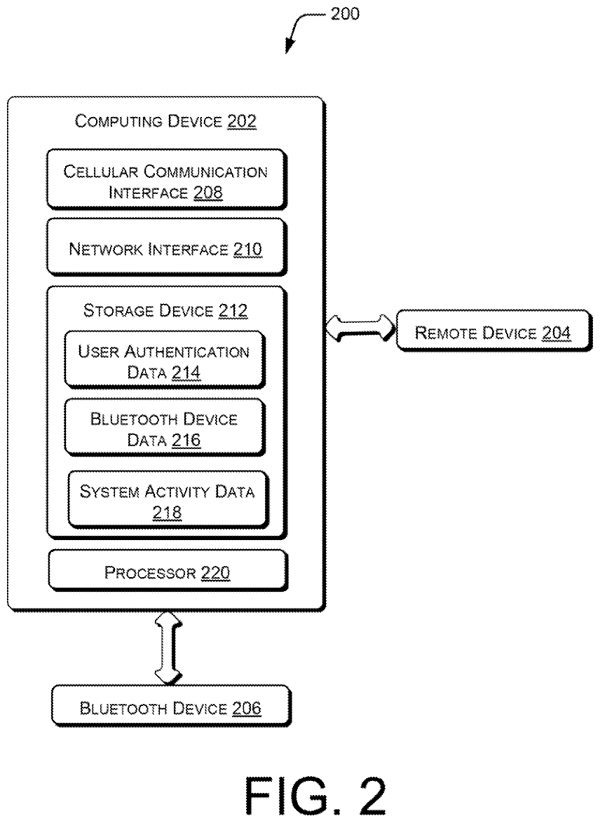

FIG. 2 illustrates a system environment 200, including a computing device 202, a remote device 204, and a Bluetooth device 206, for establishing a communication link between the computing device 202 and the remote device 204, according to an example. In an example, the computing device 202 may be similar to the computing device 100 of FIG. 1 and may include, but are not limited to, a laptop, a phablet, a tablet, a notebook computer, and a desktop. The computing device 202 includes a cellular communication interface 208 similar to the cellular communication interface 102. In an example, the cellular communication interface 208 is an LTE CAT-M interface. The computing device 202 further includes a network interface 210 similar to the network interface 104 of FIG. 1. In an example, the network interface 210 is a wired local area network interface or a wireless local area network interface. As described earlier, the remote device 204 may refer to a device through which a remote technical support service may be provided to remotely fix the computing device 202. The Bluetooth device 206 is a short-range wireless communication device that enables a user (not shown in FIG. 2) to communicate with the computing device 202 and the remote device 204.

Further, the computing device 202 includes a storage device 212. In an example, the storage device 212 may be a non-volatile memory, a volatile memory or a combination of both. Examples of the non-volatile memory may include, but are not limited to, read only memory (ROM), erasable programmable ROM, flash memories, hard disks, optical disks, and magnetic tapes. The volatile memory may include any non-transitory computer-readable medium known in the art including, such as static random-access memory (SRAM) and dynamic random-access memory (DRAM). In an example, the storage device 212 may be a shared memory, such that the storage device 212 may be simultaneously accessible by multiple applications and devices. The storage device 212 may store user authentication data 214, Bluetooth device data 216, system activity data 218.

The computing device 202 further includes a processor 220 coupled to the cellular communication interface 208, the network interface 210, and the storage device 212. The processor 220 may include microprocessors, microcomputers, microcontrollers, digital signal processors, central processing units, state machines, logic circuitries, embedded controllers, and/or any other devices that manipulate signals and data based on computer-readable instructions. Further, functions of the various elements shown in the figures, including any functional blocks labeled as “processor”, may be provided through the use of dedicated hardware as well as hardware capable of executing computer-readable instructions.

The processor 220 of the computing device 202 may establish a first communication link between the computing device 202 and the remote device 204 over the cellular communication interface 208 to contact the remote technical support service when the computing device 202 is unbootable and may establish a second communication link between the computing device 202 and the remote device 204 over the network interface 210 to contact the remote technical support service when the computing device 202 is bootable. The processor 220 of the computing device 202 may establish the first communication link or the second communication link on receiving a first user input indicative of contacting the remote technical support service in a similar manner as described earlier with respect to FIG. 1.

In an example, prior to establishing the communication link, i.e., the first communication link and the second communication link, as the case may be, the processor 220 of the computing device 202 may determine authenticity of a user providing the first user input. The authenticity of the user is determined through a basic input/output system (BIOS) (not shown) of the computing device 202 based on a service pin entered by the user, a biometric input provided by the user, a retina scan of the user, or a combination thereof. The BIOS refers to hardware or hardware and instructions to initialize, control, or operate a computing device prior to execution of an operating system (OS) of the computing device. Instructions included within a BIOS may be software, firmware, microcode, or other programming that defines or controls functionality or operation of a BIOS. In one example, a BIOS may be implemented using instructions, such as platform firmware of a computing device, executable by a processor. A BIOS may operate or execute prior to the execution of the OS of a computing device. A BIOS may initialize, control, or operate components such as hardware components of a computing device and may load or boot the OS of computing device.

In some examples, a BIOS may provide or establish an interface between hardware devices or platform firmware of the computing device and an OS of the computing device, via which the OS of the computing device may control or operate hardware devices or platform firmware of the computing device. In some examples, a BIOS may implement the Unified Extensible Firmware Interface (UEFI) specification or another specification or standard for initializing, controlling, or operating a computing device.

In an example, for authenticating the user, the processor 220 of the computing device 202 may obtain a user authorization input from the user through the BIOS of the computing device 202. The BIOS enables determining the authenticity of the user even when the computing device 202 is unbootable. The user authorization input may include the service pin, the biometric input, the retina scan, or the combination thereof. The processor 220 may check the validity of the user authorization input, for example, by matching the service pin, the biometric input, or the retina scan, as the case may be, with a corresponding parameter stored in the user authentication data 214 of the storage device 212. Matching of the user authorization input with the corresponding parameter in the user authentication data 214 confirms the authenticity of the user. After confirming the authenticity of the user, the communication link may be established between the computing device 202 and the remote device 204. If the user authorization input does not match with the stored corresponding parameter, the computing device 202 may abort the operation for contacting the remote technical support service. Therefore, the authenticity determination of the user eliminates possibility of an unauthorized access to the computing device 202 and to the remote device 204.

In an example, prior to establishing the communication link, the processor 220 of the computing device 202 may determine availability of the Bluetooth device 206 for pairing with the computing device 202. To determine the availability of the Bluetooth device 206, the processor 220 may search for Bluetooth devices pairable with the computing device 202 within a proximity of the computing device 202. In an example, the proximity may be within 10 meters from the computing device 202. On determining the availability of a pairable Bluetooth device 206 and when the computing device 202 is bootable, an operating system of the computing device 202 may assist in pairing the Bluetooth device 206 with the computing device 202. Data associated with the paired Bluetooth device 206 may be stored in the Bluetooth device data 216 of the storage device 212. Such data may include the name of the Bluetooth device 206.

When the computing device 202 is unbootable, the Bluetooth device 206 may be paired with the computing device 202 through the BIOS of the computing device 202. In an example, when the computing device 202 is unbootable, a BIOS F10 key on the keyboard of the computing device 202 may be pressed for enabling the pairing of the Bluetooth device 206 with the computing device 202. In an example, the pairing of the Bluetooth device 206 with the computing device 202 may be done after authentication of the user. In an example, the pairing of the Bluetooth device 206 with the computing device 202 may be done prior to authentication of the user. The Bluetooth device 206 may be Bluetooth earphones with a microphone, a Bluetooth keyboard, or a Bluetooth mouse.

After pairing the Bluetooth device 206 and establishing the first communication link or the second communication link between the computing device 202 and the remote device 204, the processor 220 may receive a second user input from the Bluetooth device 206. The second user input is associated with the fixing of the computing device 202. In case the Bluetooth device 206 is Bluetooth earphones with a microphone, an audio channel may be setup between the computing device 202 and the remote device 204. The user may speak with a person deployed for the remote technical support service over the audio channel to explain and resolve the technical issue affecting the operation of the computing device 202.

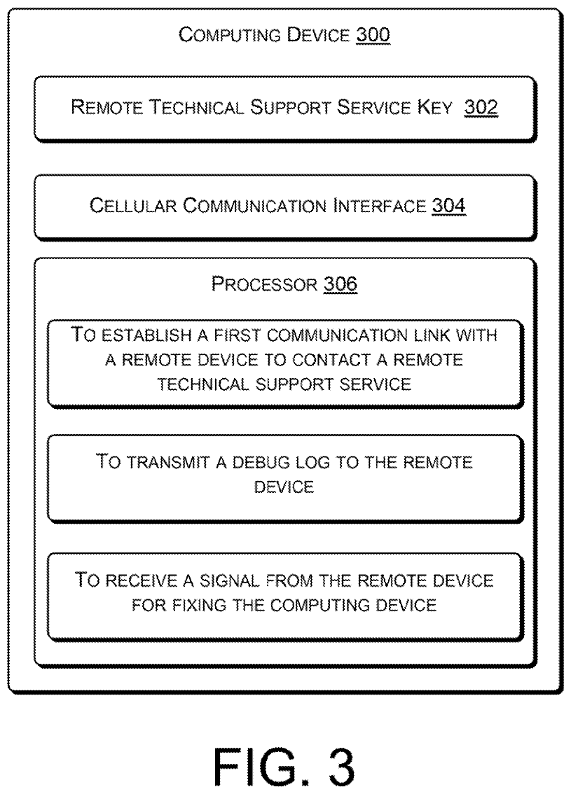

In case the Bluetooth device 206 is a Bluetooth keyboard, the second user input may be a text-based input. In case the Bluetooth device 206 is a Bluetooth mouse, the second user input may be an input on a graphic user interface of the computing device 202. An example manner in which the computing device is fixed after establishing the communication link with the remote device is further explained with reference to FIG. 3.

FIG. 3 illustrates a computing device 300 for establishing a communication link with a remote device (not shown in FIG. 3) to contact a remote technical support service, according to an example. The computing device 300 may be similar to the computing device 100 and the computing device 202 of FIG. 1 and FIG. 2, respectively. The remote device is similar to the remote device 204.

The computing device 300 includes a remote technical support service key 302. The remote technical support service key 302 is a dedicated key, for example, on a keyboard (not shown) of the computing device 300, which may be pressed by a user of the computing device 300 for contacting the remote technical support service. In an example, the remote technical support service key 302 may be color coded so that the remote technical support service key 302 can be distinguished from other keys of the keyboard of the computing device 300. In an example, the computing device 300 includes a plurality of remote technical support service keys 302. In case one remote technical support service key of the plurality of remote technical support service keys 302 is faulty, another remote technical support service key of the plurality of remote technical support service keys 302 may be pressed for contacting the remote technical support service.

The computing device 300 further includes a cellular communication interface 304. The cellular communication interface 304 may be similar to the cellular communication interface 102 and 208 for communicating with the remote device when the computing device 300 is unbootable. In an example, the cellular communication interface 304 is an LTE CAT-M interface.

Further, the computing device 300 includes a processor 306 coupled to the remote technical support service key 302 and the cellular communication interface 304. The processor 306 may be similar to the processor 106 and 220. In an example, the processor 306 receives a first user input from the remote technical support service key 302. The first user input is indicative of contacting the remote technical support service for the computing device 300. The first user input may be received in response to pressing of the remote technical support service key 302 a user of the computing device 300. In an example, the remote technical support service key 302 may be pressed by the user when the computing device 300 experiences a technical issue and is therefore unbootable.

Based on the first user input, the processor 306 establishes a first communication link with the remote device to contact the remote technical support service via the cellular communication interface 304 when the computing device 300 is unbootable. In an example, the LTE CAT-M interface enables the computing device 100 to establish the first communication link with the remote device over a 4G network or a 5G network so that a voice call may be supported between the user of the computing device 300 and the remote device for fixing the computing device 300.

Upon establishing the first communicate link between the computing device 300 and the remote device, the processor 306 transmits a debug log associated with the computing device 300 to the remote device. The debug log may include a list of possible technical issues with the computing device 300. In case of the unbootable computing device 300, the debug log may include details of the activities performed by the computing device 300 prior to being unbootable. In an example, if the computing device 300 is bootable, the debug log may include details of the activities of the application that is not working in the computing device 300. On receiving the debug log from the computing device 300, the remote device or a technical expert operating the remote device may analyse the received debug log and accordingly formulate a solution to fix the computing device 300.

After transmitting the debug log, the processor 306 of the computing device 300 receives a signal from the remote device, where the signal is an indicative of the solution to apply on the computing device 300 to fix the computing device 300. In an example, the user of the computing device 300 may be guided by the technical expert, operating the remote device. In an example, the remote device may access the computing device 300 and apply the solution to fix the computing device 300.

Further, the computing device 300 may include a network interface (not shown in FIG. 3) coupled to the remote technical support service key 302 and the processor 306. The network interface is similar to the network interface 104 and may include a wired local area network interface or a wireless local area network interface. In an example, when the computing device 300 is bootable, the processor 306 may establish a second communicate link with the remote device to contact the remote technical support service via the network interface based on the first user input.

In an example, prior to establishing the first communication link between the computing device 300 and the remote device, the processor 306 of the computing device 300 may receive a second user input. The second user input may be a service pin from the user providing the first user input, a biometric input from the user, a retina scan of the user, or a combination thereof. On receiving the second user input, the processor 306 may determine authenticity of the user through a basic input/output system (BIOS) of the computing device 300 in a similar manner as done by the processor 220.

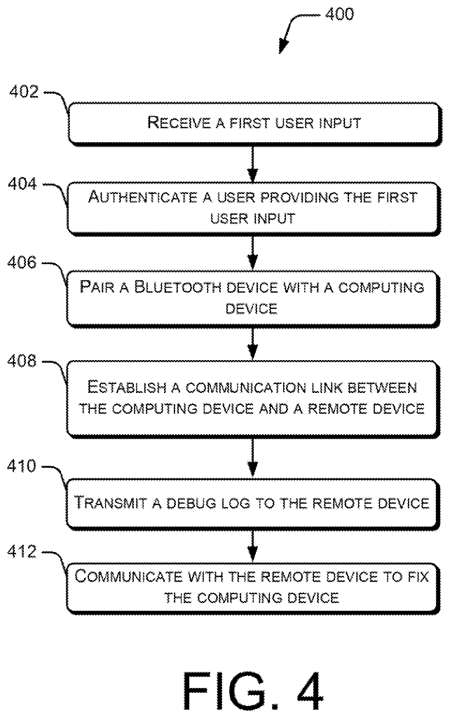

In an example, prior to establishing the first communication link, the processor 306 may determine availability of a Bluetooth device (not shown in FIG. 3) for pairing with the computing device 300. The Bluetooth device is similar to the Bluetooth device 206. The availability of the Bluetooth device may be determined in a similar manner as done in FIG. 2. The processor 306 may pair the Bluetooth device with the computing device 300 through the BIOS of the computing device 300 in response to determination of the availability of the Bluetooth device. After pairing the Bluetooth device and establishing the first communication link between the computing device 300 and the remote device, the processor 306 may receive a third user input from the Bluetooth device. The third user input is associated with fixing of the computing device 300. An example manner in which a remote technical support service is contacted to fix a computing device is further explained in detail with reference to FIG. 4.

FIG. 4 illustrates a flow diagram of a method 400 for contacting a remote technical support service to fix a computing device, according to an example of the present subject matter. The order in which the method 400 is described is not intended to be construed as a limitation, and any number of the described steps may be combined in any order to implement the method 400, or an alternative method. Further, certain steps have been omitted in the flow diagram for the sake of brevity and clarity. It may be noted that the method 400 is described with respect to the system environment 200 and the computing device 202. Similar flow diagrams may be described with respect to the computing device 100 and the computing device 300.

Referring to FIG. 4, at step 402, a first user input indicative of contacting the remote technical support service is received by the processor 220 of the computing device 202. The first user input may be received in response to pressing of a key of a keyboard of the computing device 202 by a user when the computing device 202 is experiences a technical issue. The key may be similar to the remote technical support service key 302.

At step 404, the user providing the first user input is authenticated by the processor 220 of the computing device 202, so that the computing device 202 may be protected from an unauthorized use and access. To determine the authenticity of the user, the processor 220 may prompt the user to provide a second user input. The second user input includes a service pin, a biometric input, a retina scan, or a combination thereof. In an example, when the computing device 202 is unbootable, the second user input is received through a BIOS of the computing device 202. The processor 220, on receiving the second user input, may validate the second user input by matching the service pin, the biometric input, the retina scan, or a combination thereof, as the case may be, with a corresponding parameter stored in the user authentication data 214 of the storage device 212. If the second user input matches with the stored corresponding parameter, the user is authenticated and the method 400 moves to step 406. Otherwise, the processor 220 may terminate the method 400.

At step 406, a Bluetooth device 206 is searched in the vicinity of the computing device 202 and is accordingly paired with the computing device 202. In an example, when the computing device 202 is unbootable, the Bluetooth device 206 may be paired with the computing device 202 through the BIOS of the computing device 202.

At step 408, a communicate link is established between the computing device 202 and the remote device 204 to contact the remote technical support service via a cellular communication interface 208 when the computing device 202 is unbootable or via a network interface 210 when the computing device 202 is bootable. The communication link via the cellular communication interface 208 may be referred to as a first communication link, and the communication link via the network interface 210 may be referred to as a second communication link. After establishing the communication link, the user may provide inputs associated with fixing of the computing device 202 using the paired Bluetooth device 206. In an example, the user may inform about the technical issue to the personnel operating the remote device and providing the remote technical support service.

At step 410, a debug log associated with the computing device 202 is transmitted to the remote device 204 via the communicate link. The debug log may be generated based on the system activity data 218 stored in the storage device 212.

At step 412, the computing device 202 is fixed based on a communication with the remote device 204 via the first communicate link or the second communicate link, as the case may be. In an example, the communication may be a data-based communication or a voice-based communication. On communicating with the remote device 204, the processor 220 of the computing device 202 may receive a signal indicative of a solution to be applied on the computing device 202 for fixing the technical issue. After applying the solution, the user of the computing device 202 may check whether the technical issue is fixed by the applied solution. In case the technical issue persists after applying the solution, the computing device 202 may transmit a debug log again to the remote device 204 for formulating another solution for fixing the technical issue. In case the technical issue is fixed after applying the solution, the communication link may be terminated.

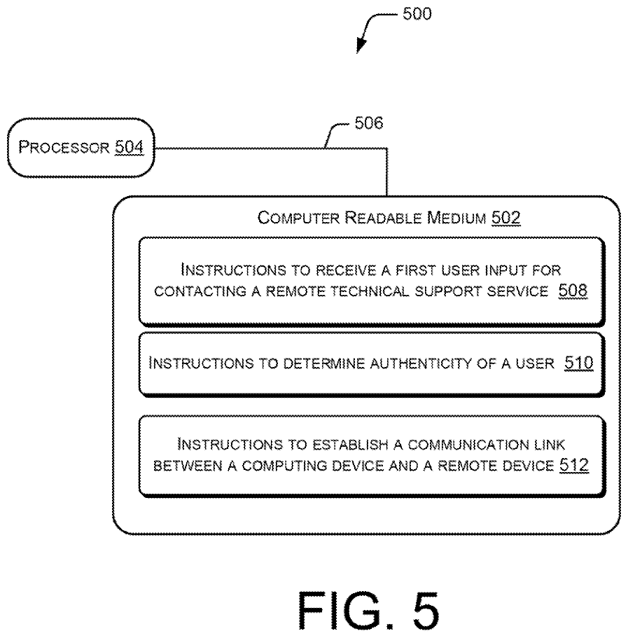

FIG. 5 illustrates a system environment 500 using a non-transitory computer-readable medium 502 for establishing a communication link between a computing device and a remote device to contact a remote technical support service, according to an example of the present subject matter. The system environment 500 includes a processor 504 communicatively coupled to the non-transitory computer-readable medium 502 through a communication channel 506 for fetching and executing computer-readable instructions from the non-transitory computer-readable medium 502.

The non-transitory computer-readable medium 502 may be, for example, an internal memory device or an external memory device. In one example, the communication channel 506 may be a direct communication channel, such as one formed through a memory read/write interface. In another example, the communication channel 506 may be an indirect communication channel, such as one formed through a network interface. In such a case, the processor 504 may access the non-transitory computer-readable medium 502 through a network (not shown).

In an example, the non-transitory computer-readable medium 502 includes a set of computer-readable and executable instructions for establishing the communication link between the computing device and the remote device to contact the remote technical support service. The set of computer-readable instructions may include instructions as explained in conjunction with FIGS. 1 to 3. The set of computer-readable instructions, referred to as instructions hereinafter, may be accessed by the processor 504 through the communication channel 506 and subsequently executed to perform acts for establishing the communication link between the computing device and the remote device to contact the remote technical support service.

Referring to FIG. 5, in an example, the non-transitory computer-readable medium may include instructions 508 that cause the processor 504 to receive a first user input from a remote technical support service key of the computing device. The remote technical support service key is a physical key, which when pressed may generate the first user input. The remote technical support service key may be similar to the remote technical support service key 302. The first user input is an indicative of contacting the remote technical support service for the computing device. In an example, a user may provide the first user input when the computing device experiences a technical issue. As described earlier, the technical issue may be such that the computing device is unbootable or the computing device is bootable but an application is non-operational.

The non-transitory computer-readable medium 502 may include instructions 510 to further cause the processor 504 to determine authenticity of the user providing the first user input. In an example, the non-transitory computer-readable medium 502 may include instructions that cause the processor 504 to determine the authenticity through a basic input/output system (BIOS) of the computing device based on a service pin entered by the user, a biometric input provided by the user, a retina scan of the user, or a combination thereof. The processor 504 may determine the authenticity of the user in a similar manner as determined by the processor 220 of FIG. 2.

The non-transitory computer-readable medium 502 may include further instructions 512 to cause the processor 504 to establish a communication link between the computing device and a remote device over a communication interface of the computing device based on determining that the user is authentic. In an example, the communication interface may be a first communication interface when an operating system of the computing device is executed or a second communication interface when the computing device is unbootable. In an example, the first communication interface is a local area network interface, such as a Wi-Fi interface. The local area network interface may be wired or wireless. In an example the second communication interface is a cellular communication interface, such as an LTE CAT-M interface.

The non-transitory computer-readable medium 502 may include further instructions to cause the processor 504 to pair a Bluetooth device with the computing device through the BIOS of the computing device prior to establishing the communication link. The Bluetooth device may be similar to the Bluetooth device 206 and pairing may be done in a similar manner as described with reference to FIG. 2. The non-transitory computer-readable medium 502 may include further instructions to cause the processor 504 to receive a second user input from the Bluetooth device associated with fixing of the computing device. The second user input may be an input to fix the computing device. In an example, the second user input may be an audio-based input or a text-based input.

Although aspects for the present disclosure have been described in a language specific to structural features and/or methods, it is to be understood that the appended claims are not limited to the specific features or methods described herein. Rather, the specific features and methods are disclosed as examples of the present disclosure.

We claim:

1. A computing device comprising:
a cellular communication interface;
a network interface; and
a processor to:
receive a first user input indicative of contacting a remote technical support service; and
based on the first user input:
establish a first communication link between the computing device and a remote device over the cellular communication interface to contact the remote technical support service when the computing device is unbootable; and
establish a second communication link between the computing device and a remote device over the network interface to contact the remote technical support service when the computing device is bootable.

2. The computing device as claimed in claim 1, wherein the cellular communication interface is a long-term evolution (LTE) category-M (CAT-M) interface.

3. The computing device as claimed in claim 1, wherein the network interface is a wired local area network interface or a wireless local area network interface.

4. The computing device as claimed in claim 1, wherein the processor is to:
prior to establishing the communication link, determine authenticity of a user providing the first user input, wherein the authenticity is determined through a basic input/output system (BIOS) of the computing device based on a service pin entered by the user, a biometric input provided by the user, a retina scan of the user, or a combination thereof.

5. The computing device as claimed in claim 1, wherein the processor is to:
determine availability of a Bluetooth device for pairing with the computing device, prior to establishing the communication link;
in response to determining the availability, pair the Bluetooth device with the computing device through a BIOS of the computing device; and
receive a second user input from the Bluetooth device associated with fixing of the computing device.

6. A computing device comprising:
a remote technical support service key;
a cellular communication interface; and
a processor to:
receive a first user input from the remote technical support service key, the first user input being indicative of contacting a remote technical support service for the computing device;
based on the first user input, establish a first communicate link with a remote device to contact the remote technical support service via the cellular communication interface when the computing device is unbootable;
transmit a debug log associated with the computing device to the remote device; and
receive a signal from the remote device, the signal being indicative of a solution to apply on the computing device to fix the computing device.

7. The computing device as claimed in claim 6, wherein the cellular communication interface is a long-term evolution (LTE) category-M (CAT-M) interface.

8. The computing device as claimed in claim 6, further comprising a network interface, wherein the processor is to:
based on the first user input, establish a second communicate link with a remote device to contact the remote technical support service via the network interface when the computing device is bootable.

9. The computing device as claimed in claim 8, wherein the network interface is a wired local area network interface or a wireless local area network interface.

10. The computing device as claimed in claim 6, wherein the processor is to:
prior to establishing the first communication link, receive a second user input comprising a service pin from a user providing the first user input, a biometric input from the user, a retina scan of the user, or a combination thereof; and
determine authenticity of the user through a basic input/output system (BIOS) of the computing device based on the second user input.

11. The computing device as claimed in claim 6, wherein the processor is to:
determine availability of a Bluetooth device for pairing with the computing device, prior to establishing the first communication link:
in response to determining the availability, pair the Bluetooth device with the computing device through a BIOS of the computing device; and
receive a third user input from the Bluetooth device associated with fixing of the computing device.

12. A non-transitory computer-readable medium comprising computer-readable instructions, which, when executed by a processor of a computing device, cause the processor to:
receive a first user input from a remote technical support service key of the computing device, the first user input being indicative of contacting a remote technical support service for the computing device;
determine authenticity of a user providing the first user input; and
based on determining that the user is authentic, establish a communication link between the computing device and a remote device over a communication interface of the computing device, wherein a first communication interface is used when an operating system of the computing device is executed, and wherein a second communication interface is used when the computing device is unbootable.

13. The non-transitory computer-readable medium as claimed in claim 12, wherein the first communication interface is a local area network interface, and wherein the second communication interface is a long-term evolution (LTE) category-M (CAT-M) interface.

14. The non-transitory computer-readable medium as claimed in claim 12, wherein the authenticity is determined through a basic input/output system (BIOS) of the computing device based on a service pin entered by the user, a biometric input provided by the user, a retina scan of the user, or a combination thereof.

15. The non-transitory computer-readable medium as claimed in claim 12, wherein the computer-readable instructions cause the processor to:
prior to establishing the communication link, pair a Bluetooth device with the computing device through a BIOS of the computing device; and
receive a second user input from the Bluetooth device associated with fixing of the computing device.
